(19) United States
(12) Patent Application Publication
(10) Pub. No.: US 2025/0254127 A1
(43) Pub. Date: Aug. 7, 2025

(54) METHOD, APPARATUS AND DEVICE FOR DISTRIBUTIVELY CLASSIFYING NETWORK TRAFFIC, AND STORAGE MEDIUM

(71) Applicant: PENG CHENG LABORATORY, Shenzhen (CN)

(72) Inventors: Qing LI, Shenzhen (CN); Jiaye LIN, Shenzhen (CN); Guorui XIE, Shenzhen (CN); Kejun LI, Shenzhen (CN); Yong JIANG, Shenzhen (CN)

(73) Assignee: PENG CHENG LABORATORY, Shenzhen (CN)

(21) Appl. No.: 19/186,522

(22) Filed: Apr. 22, 2025

Related U.S. Application Data
(63) Continuation of application No. PCT/CN2024/081884, filed on Mar. 15, 2024.

(30) Foreign Application Priority Data
Sep. 27, 2023 (CN) 202311271277.3

(51) Int. Cl. H04L 47/2441

(52) U.S. Cl. CPC H04L 47/2441

(57) ABSTRACT

Disclosed are a method, an apparatus and a device for distributively classifying network traffic, and a storage medium. The method includes: splitting an initial ensemble model into a plurality of classification paths, and reorganizing and enhancing the initial ensemble model based on the plurality of classification paths to obtain a plurality of enhanced base models, the initial ensemble model is configured to perform classification on the network traffic; determining an enhanced base model allocation scheme through an allocation scheme in the offline phase and an allocation scheme in the online phase; and deploying the plurality of enhanced base models to a plurality of switches based on the enhanced base model allocation scheme, and classifying the network traffic through the plurality of switches to obtain a classification result.

### CROSS-REFERENCE TO RELATED APPLICATIONS

This application is a continuation application of International Application No. PCT/CN2024/081884, filed on Mar. 15, 2024, which claims priority to Chinese Patent Application No. 202311271277.3, filed on Sep. 27, 2023. The disclosures of the above-mentioned applications are incorporated herein by reference in their entireties.

### TECHNICAL FIELD

The present application relates to the technical field of Internet, and in particular to a method, an apparatus and a device for distributively classifying network traffic, and a storage medium.

### BACKGROUND

In recent years, network classification technology based on machine learning has been widely used in fields such as traffic classification, aiming to simplify network management, improve network service quality, and ensure network security.

Current network traffic classification schemes are all centralized, that is, a complete but cumbersome model is deployed on a single switch. However, in the actual classification process, due to the limited resources of a single switch, it is difficult to support the deployment of high-precision large-scale models. In addition, for the deployment of a full-network model covering all traffic, the same model is repeatedly deployed on a plurality of switches, which will cause a large amount of network device resources to be wasted on processing traffic that has already been processed by the first switch. Therefore, the industry is in urgent need of a method that can improve the classification accuracy of network traffic classification in scenarios with limited network resources.

The above contents are only used to assist in understanding the technical solution of the present application and do not constitute an admission that the above contents are prior art.

### SUMMARY

The main objective of the present application is to provide a method, an apparatus and a device for distributively classifying network traffic, and a storage medium, aiming to solve the technical problem that the existing technology cannot improve the classification accuracy of network traffic classification in scenarios with limited network resources.

In order to achieve the above objective, the present application provides a method for distributively classifying network traffic, the method including the following steps:
splitting an initial ensemble model into a plurality of classification paths, and reorganizing and enhancing the initial ensemble model based on the plurality of classification paths to obtain a plurality of enhanced base models, the initial ensemble model is configured to perform classification on the network traffic;
determining an enhanced base model allocation scheme through an allocation scheme in the offline phase and an allocation scheme in the online phase; and
deploying the plurality of enhanced base models to a plurality of switches based on the enhanced base model allocation scheme, and classifying the network traffic through the plurality of switches to obtain a classification result.

In an embodiment, the splitting of the initial ensemble model into the plurality of classification paths includes:
determining a flow set based on flow sequence numbers of original data packets, the flow sequence number of a data packet is obtained by performing a hash operation on preset features in the original data packet;
extracting crucial flow-level features from the original data packet, and constructing a training set based on the crucial flow-level features; and
generating a tree-based ensemble model based on the flow set and the training set, and splitting the initial ensemble model into a plurality of classification paths through the tree-based ensemble model.

In an embodiment, the reorganizing and enhancing the initial ensemble model based on the plurality of classification paths to obtain the plurality of enhanced base models includes:
storing the plurality of classification paths in a path pool, and reorganizing the classification paths in the path pool to obtain a plurality of base models;
performing model filtering on the plurality of base models to select base models with the best performance; and
enhancing the selected base models by supplementing with the plurality of classification paths with higher priorities to obtain enhanced base models.

In an embodiment, after the performing model filtering on the plurality of base models to obtain the selected base models, the method further includes:
obtaining traffic subsets, sample true classes, and sample predicted classes respectively corresponding to the plurality of classification paths; and
calculating priorities of the plurality of classification paths based on the traffic subsets, the sample true classes and the sample predicted classes.

In an embodiment, the determining the enhanced base model allocation scheme through the allocation scheme in the offline phase and the allocation scheme in the online phase includes:
calculating an objective function of the plurality of enhanced base models in the offline phase based on topology awareness, and determining the allocation scheme for the offline phase based on the objective function and a Genetic Algorithm;
modeling a dynamic traffic transmission process of the plurality of enhanced base models in the online phase as a Markov decision process, and determining the allocation scheme in the online phase based on a deep reinforcement learning method, the Markov decision process is established to facilitate the deep reinforcement learning method; and
determining an enhanced base model allocation scheme based on the allocation scheme in the offline phase and the allocation scheme in the online phase.

In an embodiment, the deploying the plurality of enhanced base models to the plurality of switches based on the enhanced base model allocation scheme, and classifying the network traffic through the plurality of switches to obtain the classification results includes:
converting classification paths in the plurality of enhanced base models into range match rules based on the enhanced base model allocation scheme;
deploying the range match rules to the plurality of switches; and
classifying the network traffic based on the range match rules by the plurality of switches to obtain the classification result.

In an embodiment, the method for distributively classifying network traffic further includes:
in response to a change in current network resources of a switch, obtaining a rule priority corresponding to the range match rule contained in the switch; and
adjusting the range match rule based on the rule priority to obtain an updated enhanced base model.

In addition, to achieve the above purpose, the present application further provides an apparatus for distributively classifying network traffic, including:
a model processing module configured to split an initial ensemble model into a plurality of classification paths, and reorganize and enhance the initial ensemble model based on the plurality of classification paths to obtain a plurality of enhanced base models, the initial ensemble model is configured to perform classification on the network traffic;
a scheme determination module configured to determine an enhanced base model allocation scheme through an allocation scheme in the offline phase and an allocation scheme in the online phase; and
a traffic classification module configured to deploy the plurality of enhanced base models to a plurality of switches based on the enhanced base model allocation scheme, and classify the network traffic through the plurality of switches to obtain a classification result.

In addition, to achieve the above-mentioned purpose, the present application further provides a device for distributively classifying network traffic, which includes: a memory, a processor, and a program for distributively classifying network traffic stored in the memory and executable on the processor, the program for distributively classifying network traffic is configured to implement the method for distributively classifying network traffic as described above.

In addition, to achieve the above-mentioned purpose, the present application further provides a storage medium, on which a program for distributively classifying network traffic is stored. When the program for distributively classifying network traffic is executed by a processor, the steps of the method for distributively classifying network traffic described above are implemented.

In the present application, a plurality of enhanced base models is obtained by splitting the initial ensemble model into plurality of classification paths, and reorganizing and enhancing the initial ensemble model based on the plurality of classification paths, the initial ensemble model is configured to classify network traffic and serves as the basis for generating the plurality of enhanced base model; the enhanced base model allocation scheme is determined through the allocation scheme of the offline phase and the allocation scheme of the online phase; the plurality of enhanced base models are deployed to a plurality of switches based on the enhanced base model allocation scheme, and the network traffic is classified through the plurality of switches to obtain classification results. Compared with the conventional network traffic classification method, the above method of the present application is based on reorganizing and enhancing the models of the plurality of classification paths split from the initial ensemble model to obtain the enhanced base models, and deploying the enhanced base models to a plurality of switches based on the enhanced base model allocation scheme, so as to classify the network traffic through the plurality of switches, thereby improving the classification accuracy of network traffic classification in scenarios with limited network resources.

### BRIEF DESCRIPTION OF THE DRAWINGS

FIG. 1 is a schematic diagram of the structure of a device for distributively classifying network traffic in a hardware operating environment according to an embodiment of the present application.

FIG. 2 is a flowchart of a method for distributively classifying network traffic according to an embodiment of the present application.

FIG. 3 is a flowchart of the method for distributively classifying network traffic according to an embodiment of the present application.

FIG. 4 is a flowchart of the method for distributively classifying network traffic according to an embodiment of the present application.

FIG. 5 is a schematic diagram of a lightweight ensemble generic optional model design for the method for distributively classifying network traffic according to an embodiment of the present application.

FIG. 6 is a flowchart of the method for distributively classifying network traffic according to an embodiment of the present application.

FIG. 7 is a flowchart of the method for distributively classifying network traffic according to an embodiment of the present application.

FIG. 8 is a flowchart of the method for distributively classifying network traffic according to an embodiment of the present application.

FIG. 9 is a flowchart of the method for distributively classifying network traffic according to an embodiment of the present application.

FIG. 10 is a structural block diagram of an apparatus for distributively classifying network traffic according to an embodiment of the present application.

The realization of the purpose, functional features and advantages of the present application will be further described with reference to the embodiments and the accompanying drawings.

### DETAILED DESCRIPTION OF THE EMBODIMENTS

It should be understood that the specific embodiments described herein are only used to explain the present application and are not used to limit the present application.

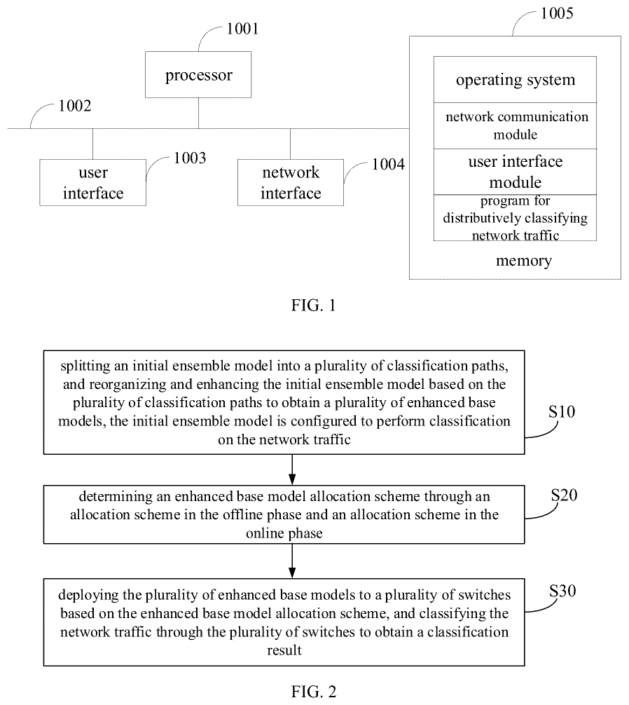

FIG. 1 is a schematic diagram of the structure of a device for distributively classifying network traffic in a hardware operating environment according to an embodiment of the present application.

As shown in FIG. 1, the device for distributively classifying network traffic may include: a processor 1001, such as a central processing unit (CPU), a communication bus 1002, a user interface 1003, a network interface 1004, and a memory 1005. The communication bus 1002 is used to realize the connection and communication between these components. The user interface 1003 may include a display, an input unit such as a keyboard, and the user interface 1003 may also include a standard wired interface and a wireless interface. The network interface 1004 may include a standard wired interface and a wireless interface (such as a wireless fidelity (Wi-Fi) interface). The memory 1005 may be a high-speed random access memory (RAM), or a stable non-volatile memory (NVM), such as a disk storage. The memory 1005 may also be a storage device independent of the aforementioned processor 1001.

Those skilled in the art will appreciate that the structure shown in FIG. 1 does not constitute a limitation on the device for distributively classifying network traffic, and may include more or fewer components than shown in the figure, or a combination of certain components, or a different arrangement of components.

As shown in FIG. 1, the memory 1005 as a storage medium may include an operating system, a network communication module, a user interface module, and a program for distributively classifying network traffic.

In the device for distributively classifying network traffic shown in FIG. 1, the network interface 1004 is mainly used for data communication with the network server. The user interface 1003 is mainly used for data interaction with the user. The processor 1001 and the memory 1005 in the device for distributively classifying network traffic of the present application can be set in the device for distributively classifying network traffic, and the device for distributively classifying network traffic calls the program for distributively classifying network traffic stored in the memory 1005 through the processor 1001, and executes the method for distributively classifying network traffic provided in the embodiment of the present application.

Embodiments of the present application provide a method for distributively classifying network traffic. FIG. 2 is a flowchart of the method for distributively classifying network traffic according to an embodiment of the present application.

In this embodiment, the method for distributively classifying network traffic includes the following steps:

Step S10: splitting an initial ensemble model into a plurality of classification paths, and reorganizing and enhancing the initial ensemble model based on the plurality of classification paths to obtain a plurality of enhanced base models, the initial ensemble model is configured to perform classification on the network traffic.

It should be noted that the execution subject of the method of this embodiment can be a terminal device with model deployment, data processing and program running functions, such as a switch, in particular to a programmable switch, or an electronic device with the same or similar functions, such as the above-mentioned device for distributively classifying network traffic. The following uses the device for distributively classifying network traffic (hereinafter referred to as the classification device) as an example to illustrate the following embodiments.

It is understandable that the above initial ensemble model can be a centralized classification model. This type of model usually deploys a complete but heavy model on a single switch, which makes it difficult to support the deployment of high-precision large-scale models. In addition, for the full network model deployment covering all traffic, the same model is repeatedly deployed on a plurality of switches, resulting in a large amount of network device resources being wasted on processing traffic that has already been processed by the first switch.

It should be understood that the above classification path may refer to a series of classification classes passed through when an entity or document is assigned to a specific classification.

In an embodiment, the initial ensemble model can be reorganized and enhanced by a lightweight ensemble generic optional model design module. More specifically, since different classification paths correspond to different traffic subsets, the above-mentioned classification paths can be combined to perform coarse-grained model reorganization on the above-mentioned initial ensemble model, and the models after the coarse-grained model reorganization can be enhanced through fine-grained model enhancement.

Step S20: determining an enhanced base model allocation scheme through an allocation scheme in the offline phase and an allocation scheme in the online phase.

It should be noted that the allocation scheme in the above-mentioned offline phase can be the optimal allocation scheme for enhancing the base models when the models are in the offline phase, and the allocation scheme in the above-mentioned online phase can be the optimal allocation scheme for enhancing the base model when the model is in the online phase.

In an embodiment, when a lightweight ensemble generic optional model is deployed across the entire network, resource consumption, traffic coverage, and classification accuracy are important indicators for determining the optimal allocation scheme for the enhanced base model. However, directly modeling the correspondence between the model allocation scheme and network traffic is challenging and unreliable. Due to the dynamic nature of traffic, the current allocation scheme may not be able to effectively adapt to future traffic. To overcome this problem, this embodiment may adopt a two-phase (i.e., the above-mentioned offline phase and online phase) resource-aware model allocation strategy.

Step S30: deploying the plurality of enhanced base models to a plurality of switches based on the enhanced base model allocation scheme, and classifying the network traffic through the plurality of switches to obtain a classification result.

It should be noted that the above-mentioned switch can be a network device used for forwarding electrical (optical) signals, which can provide an exclusive electrical signal path for any two network nodes connected to the switch.

In an embodiment, the lightweight ensemble generic optional model in this embodiment is the core component of the classification device, so it is first compared with four conventional ensemble models, namely Random Forest, Extra Tree, Adaboost algorithm and Gradient Boosting Decision Tree. The comparison focuses on the number of classification passes required to achieve the same accuracy and F1 score. This embodiment conducts experiments on three public datasets, namely UNSW-NB15, BoT-IoT, and CIC-IDS, to identify whether real-world traffic is malicious or benign. Each dataset is divided into two parts, 80% for training and 20% for testing. A lightweight ensemble generic optional model can achieve the same performance level with fewer classification paths. The lightweight ensemble generic optional model (W/O) represents a trimmed version without fine-grained model enhancements, while the lightweight ensemble generic optional model (W/O) is the full version. Both versions of the lightweight ensemble generic optional model achieve the same accuracy as random forest while significantly reducing the number of classification paths. The lightweight ensemble generic optional model (W/O) demonstrates the contribution of path-based model splitting and coarse-grained model reorganization in forming lightweight base models and eliminating redundant information. The fine-grained model enhancement in the lightweight ensemble generic optional model (W/O) further enhances the base model by inserting valuable paths as supplements to ensure the capability of the classification paths. In contrast, the conventional ensemble models suffer from heavy sizes, which limits their practical deployment and requires a compromise between model size and classification performance. The lightweight ensemble generic optional model is not subject to this limitation. And, since only one enhanced base model needs to be deployed on each switch, fewer resources are required.

In order to demonstrate the effectiveness and superiority of In-Forest (i.e., the model in the classification device of this embodiment), this embodiment extend the lightweight ensemble generic optional model for network-wide deployment and uses UNSW-NB15 as the traffic dataset and Abilene as the network topology to simulate traffic transmission. Random forest and decision tree are selected for comparison to demonstrate the performance of the two-phase resource-aware model allocation. Since the existing solutions lack a distributed deployment mechanism for the whole network, four deployment methods (random forest—100%, random forest—70%, random forest—20% and decision tree—100%) are added for expansion and used as baselines: (1) Random Forest—100%: Random Forest is deployed on all switches. (2) Random Forest—70% and Random Forest—20%: Random Forest is deployed on 70% or 20% of the switches. (3) Decision Tree—100%: Decision Tree is deployed on all switches. (4) In-Forest: An offline phase is used to select the optimal allocation scheme for the enhanced base model. In-Forest can achieve optimal model allocation by adjusting D and E to adapt to different resource scenarios, and achieve optimal model scaling through a lightweight model update mechanism. Larger D and E means that the network has more hardware resources available for model deployment. In contrast, when resources are limited, network administrators will set smaller D and E. Compared with Random Forest—100%, In-Forest can improve accuracy while reducing the number of range match rules. Compared with DT-100%, In-Forest has higher accuracy. Since the models are the same, the traffic will not have any accuracy improvement after passing through the plurality of decision trees. In contrast, In-Forest can improve accuracy by aggregating the classification results of different enhanced base models, and can cover all traffic without rescheduling.

This embodiment splits the initial ensemble model into a plurality of classification paths, and reorganizes and enhances the initial ensemble model based on the plurality of classification paths to obtain a plurality of enhanced base models, the initial ensemble model is used to classify network traffic; determines the enhanced base model allocation scheme through the allocation scheme in the offline phase and the allocation scheme in the online phase; deploys the plurality of enhanced base models to plurality of switches based on the enhanced base model allocation scheme, and classifies the network traffic through the plurality of switches to obtain classification results. Compared with the conventional network traffic classification method, the above method of this embodiment is based on reorganizing and enhancing the models of the plurality of classification paths split from the initial ensemble model to obtain the enhanced base models, and deploys the enhanced base models to plurality of switches based on the enhanced base model allocation scheme, so that the network traffic is classified through the plurality of switches, thereby improving the classification accuracy of network traffic classification in scenarios with limited network resources.

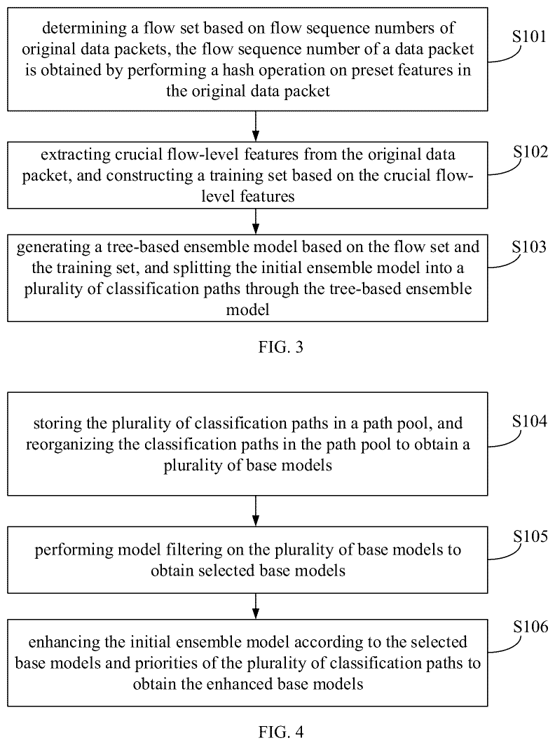

As shown in FIG. 3, which is a flowchart of the method for distributively classifying network traffic according to an embodiment of the present application, in an embodiment, in order to simplify the complex initial ensemble model into a plurality of classification paths, thereby preventing the initial ensemble model from occupying a large amount of network resources, the step S10 may include:

Step S101: determining a flow set based on flow sequence numbers of an original data packets, the flow sequence number of a data packet is obtained by performing a hash operation on preset features in the original data packet.

It should be understood that the above-mentioned flow sequence number is obtained by performing a hash operation on the preset features in the original data packet, the preset features may include a five-tuple (IP address, source port, destination IP address, destination port and transport layer protocol).

In an embodiment, the original data packets may be grouped into flows based on hash values calculated from preset features (e. g., five-tuple). Then, data packets belonging to the first F flows may be selected to construct the training set, where F represents a configurable number of flows.

Step S102: extracting crucial flow-level features from the original data packet, and constructing a training set based on the crucial flow-level features.

It is understandable that the above-mentioned crucial flow-level feature may be an average data packet length, or a minimum data packet length, a maximum data packet length, etc., which is not limited by the embodiment.

Step S103: generating a tree-based ensemble model based on the flow set and the training set, and splitting the initial ensemble model into a plurality of classification paths through the tree-based ensemble model.

In an embodiment, it can be starting from the first internal node (i.e., the root node) of the tree in the tree-based ensemble model and traversing a series of internal nodes in sequence. Each internal node contains a classification feature and a decision threshold. The features of the sample are compared with the threshold to determine the direction of branching to the left or right. This branching process continues until it reaches a leaf node, and each leaf node contains the classification results of the ensemble model. For each path from the root node to the leaf node in the ensemble model, it can be encoded as the above classification path.

In an embodiment, as shown in FIG. 4, in order to improve the classification capability of the model through model reorganization and model enhancement, thereby achieving distributed deployment, the step S10 may also include:

Step S104: storing the plurality of classification paths in a path pool, and reorganizing the classification paths in the path pool to obtain a plurality of base models.

Step S105: performing model filtering on the plurality of base models to obtain selected base models.

In an embodiment, the above-mentioned plurality of base models can be filtered by the Top-K filtering method to obtain the selected base models. The Top-K filtering method can be used to filter out the top K most valuable or relevant items from a set. More specifically, the Top-K filtering method sets a threshold K, sorts the items in the set according to a certain indicator, and selects the top K items as the results. This indicator can be a certain metric, rating, score, weight or other importance indicator, depending on the specific scenario.

Step S106: enhancing the initial ensemble model according to the selected base models and priorities of the plurality of classification paths to obtain the enhanced base models.

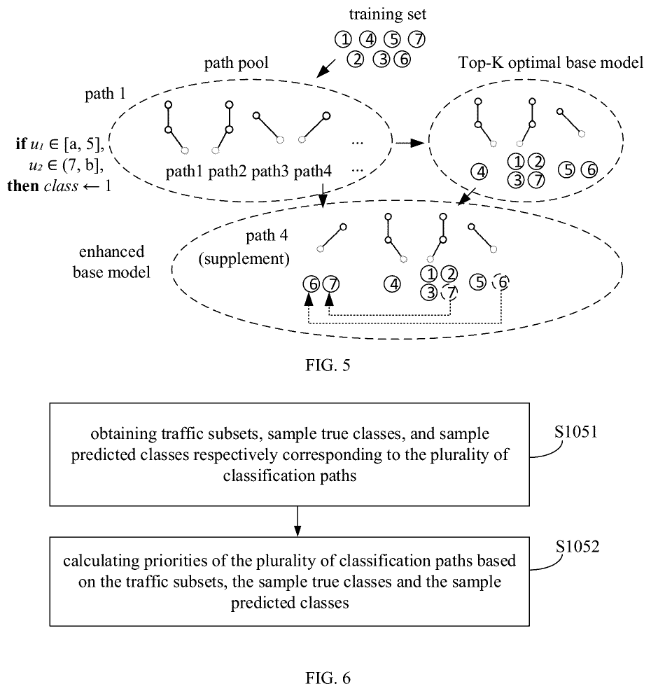

In an embodiment, reference may be made to FIG. 5, which is a schematic diagram of a lightweight ensemble generic optional model design for the method for distributively classifying network traffic according to an embodiment of the present application. For the classification paths that are not selected by the Top-K filtering method of the combined model, there are still important values, such as path 4 in FIG. 2. Path 4 accurately classifies samples 6 and 7, and can be used as a supplement to the base model to correct misclassified samples. In this scenario, both path 3 and path 4 can process sample 6. However, considering that path 4 has a higher priority, it is selected to achieve accurate classification of sample 6. The same logic applies to sample 7. By combining base models with their corresponding supplements, enhanced base models can be formed. The lightweight ensemble generic optional model is obtained by aggregating the enhanced base models to avoid overfitting, thereby improving the classification accuracy. It is worth noting that the classification paths of the enhanced base models will be converted into interpretable range match rules and deployed on programmable switches.

In an embodiment, as shown in FIG. 6, in order to sort the priorities of the classification paths so as to establish models with better performance based on the classification paths with higher priorities, after step S105, the following may also be included:

Step S1051: obtaining traffic subsets, sample true classes, and sample predicted classes respectively corresponding to the plurality of classification paths.

Step S1052: calculating priorities of the plurality of classification paths based on the traffic subsets, the sample true classes and the sample predicted classes.

In an embodiment, in order to ensure better performance after aggregation, the performance of each base model needs to be improved as much as possible. All classification paths are sorted in descending order according to their priorities. The priority calculation formula is as follows:

$$P {r}_{j} ← \frac{{\sum }_{y ∈ {𝒳}_{j}} ( y == \hat{y} )}{\vert {𝒳}_{j} \vert}$$

[symbol] represents the traffic subset corresponding to the path j, y and ŷ represents the true class and sample predicted class respectively.

This embodiment determines a flow set based on flow sequence numbers of original data packets, the flow sequence number of a data packet is obtained by performing a hash operation on preset features in the original data packet; extracts crucial flow-level features from the original data packets, and constructs a training set based on the crucial flow-level features; generates a tree-based ensemble model based on the flow set and the training set, and splits the initial ensemble model into the plurality of classification paths through the tree-based ensemble model; stores the plurality of classification paths in a path pool, and reorganizes the classification paths in the path pool to obtain plurality of base models; performs model filtering on the plurality of base models to obtain selected base models; performs model enhancement on the selected based models according to the priorities of the plurality of classification paths to obtain enhanced base models; obtains traffic subsets, sample true classes, and sample predicted classes corresponding to the plurality of classification paths respectively; and calculates the priorities of the plurality of classification paths based on the traffic subsets, the sample true classes, and the sample predicted classes. Compared with conventional network traffic classification methods, the above method in this embodiment simplifies the complex initial ensemble model into a plurality of classification paths, thereby avoiding the initial ensemble model from occupying a large amount of network resources, and improves the classification ability of the model through model reorganization and model enhancement, thereby realizing the distributed deployment of the enhanced base model.

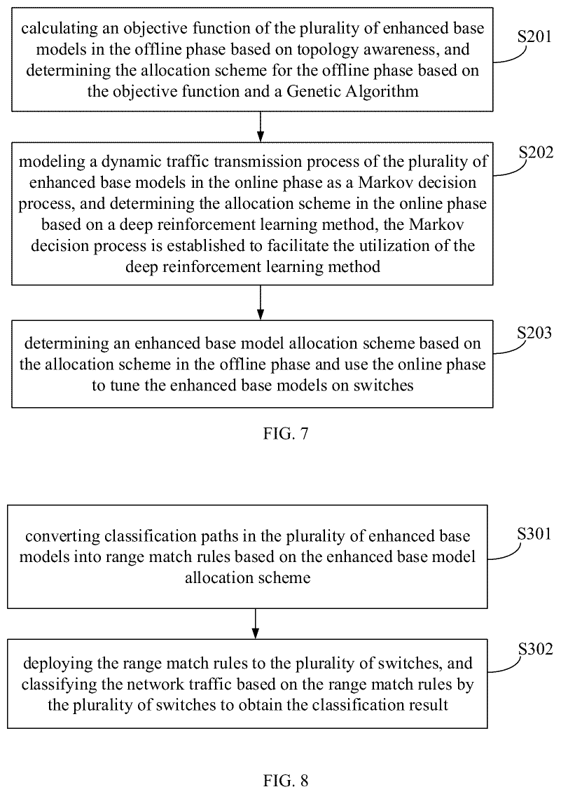

As shown in FIG. 7, which is a flowchart of the method for distributively classifying network traffic according to an embodiment of the present application, in an embodiment, in order to allocate enhanced base models to classify the corresponding network traffic across the network, thereby improving the classification accuracy, the step S20 may include:

Step S201: calculating an objective function of the plurality of enhanced base models in the offline phase based on topology awareness, and determining the allocation scheme for the offline phase based on the objective function and a Genetic Algorithm.

In an embodiment, an offline phase is adopted to obtain topology-aware model allocation schemes under different resource scenarios, where the traffic coverage is converted into the path coverage between subnet pairs, and the classification accuracy is converted into the diversity of enhanced base models on all paths. Then, the model allocation problem can be simplified as follows:

$${max}_{𝒟} {α}_{1} {\sum }_{n = 1}^{N} Step ( {\sum }_{w = 1}^{W} {p}_{{n}_{w}} {\sum }_{b = 1}^{B} {𝒟}_{w , b} ) + {α}_{2} {\sum }_{n = 1}^{N} {\sum }_{b = 1}^{B} Step ( {\sum }_{w = 1}^{w} {p}_{{n}_{w}} {𝒟}_{w , b} ) - {α}_{3} {\sum }_{w = 1}^{W} {\sum }_{b = 1}^{B} {𝒟}_{w , b} {e}_{b}$$

$$s . t . {\sum }_{w = 1}^{W} Step ( {\sum }_{b = 1}^{B} {𝒟}_{w , b} ) \leq D ;$$

$${\sum }_{w = 1}^{W} {\sum }_{b = 1}^{B} {𝒟}_{w , b} {e}_{b} \leq E ;$$

$${\sum }_{b = 1}^{B} {𝒟}_{w , b} \leq 1 , w = 1 , … , W ;$$

$${𝒟}_{w , b} ∈ \{ 0 , 1 \} , w = 1 , … , W , b = 1 , … , B .$$

W can represent the number of switches, B can represent the number of enhanced base models, N can represent the number of subnet pairs, D can represent the maximum number of deployable switches, E can represent the maximum number of range match rules that can be stored in the entire network, [symbol] _{w,b} can represent whether the enhanced base model is deployed on the switch, pₙ can represent the selected path between subnet pairs n, and e_{b} can represent the number of rules of the enhanced base model b.

It can be understood that the above objective function is to optimize the path coverage and model diversity while minimizing the required range match rules. D represents the variable used to determine the model allocation scheme. pₙ is a one-dimensional vector with a length of W encoded with binary values, indicating whether switch w is located on the selected path between the subnet pair n. The function Step (·) converts values greater than 0 to 1 and other values to 0. In order to ensure the comparability between the three metrics in the objective function, they are normalized to the range of [0, 1]. α₁, α₂ and α₃ are the weights of the metrics, with values of α₁=0.6, α₂=0.2 and α₃=0.2. By adjusting D and E, model allocation schemes under different resource scenarios can be obtained.

In an embodiment, the Genetic Algorithm can be used. A population containing many D with different values is randomly generated, and each D is flattened into a one-dimensional vector with a length of W×B. Each vector represents a candidate scheme and is evaluated by fitness (i.e., the objective function in the model allocation problem). The population is iterated, and solutions with higher fitness are more likely to reproduce offspring in the next iteration. Offspring is generated through crossover and mutation, replacing some existing solutions to maintain the population size. The process is iterated until the fitness converges. For solutions that do not meet the constraints, a large negative value is assigned to the fitness. The solution with the highest fitness is considered to be the allocation scheme for the above-mentioned offline phase.

Step S202: modeling a dynamic traffic transmission process of the plurality of enhanced base models in the online phase as a Markov decision process, and determining the allocation scheme in the online phase based on a deep reinforcement learning method, the Markov decision process is established to facilitate the utilization of the deep reinforcement learning method.

In an embodiment, traffic transmission can be modeled as a Markov decision process to effectively utilize deep reinforcement learning methods. The Markov decision process (S, A, R, T) is defined by a four-tuple, where S represents the state space, A represents the action space, R represents the reward space, and T represents the state transition probability. At time step t, the classification device receives network information St, determines the model allocation scheme at, and then obtains the reward rt. The Markov decision process aims to find the optimal policy that maximizes the objective function. The Proximal Policy Optimization algorithm is used to effectively solve it, which is known for improving sampling efficiency and reducing training variance. Importance sampling is used to effectively utilize the data sampled from the old policy parameters.

In the state space, flow features (five-tuples for each flow), traffic distribution (number of flows in a link), and the current model allocation scheme are considered. The action output of each switch is a vector with a length of B+1. The first B dimension represents the deployment probability of each enhanced base model, while the last dimension represents the non-deployment probability. In order to determine the allocation scheme in the online phase of the above network, the actions with the highest probability in each switch are selected and combined into a global action.

Step S203: determining an enhanced base model allocation scheme based on the allocation scheme in the offline phase and use the online phase to tune the enhanced base models on switches.

In an embodiment, a stable learning mechanism is adopted to ensure the effectiveness of the online phase. The deployed switches are determined through the offline phase, and then the online phase is used to adjust the enhanced base model on these switches. This can reduce the dimension of the action space to achieve faster convergence. In addition, the allocation scheme in the offline phase will be used as the initial value of the Proximal Policy Optimization algorithm, and it will be further explored and improved by the Proximal Policy Optimization algorithm. If the action output is not better than the offline phase, the model allocation scheme remains unchanged. The scheme in the online phase also needs to meet the constraints. For schemes that perform worse than the offline phase or do not meet the constraints, a penalty value is added to the reward.

In an embodiment, as shown in FIG. 8, in order to ensure that corresponding rules are deployed in each switch, so that the plurality of switches can independently solve the classification task, further improving the classification efficiency, the step S30 may include:

Step S301: converting classification paths in the plurality of enhanced base models into range match rules based on the enhanced base model allocation scheme.

In an embodiment, each enhanced base model can be translated into a single match-action table that matches all features. Each classification path of the enhanced base model is converted into a range match rule and stored in the table. This model representation method ensures the flexibility of model updates. Specifically, the features of the data correspond to the numerical range and are represented in the form of an interpretable range match rule, which is then installed in the programmable switch.

For example, if the enhanced base model classifies the data of feature u₁≤5 and feature u₂>7 as benign (represented by class 1), then a rule can be obtained as follows: if u₁∈[a, 5], u₂∈(7, b], then class←1.

Step S302: deploying the range match rules to the plurality of switches, and classifying the network traffic based on the range match rules by the plurality of switches to obtain the classification result.

It should be understood that the packet header field can be used to record the classification results of the model deployed on the previous switch. Specifically, the variable prob is initialized with the value of H, indicating the maximum number of switches between the subnet pairs. In the anomaly detection task, if an enhanced base model classifies the incoming flow as malicious, prob will be increased by 1. Subsequently, the value of prob is checked. If prob exceeds H, it indicates that at least one model predicts that the flow is malicious, and the larger the prob value, the higher the confidence. On the contrary, if prob is less than H, it means that at least two previous models classify the flow as benign, which means that the current model result may be wrong, and the result will be corrected by majority voting. When prob equals H, the forwarding of the flow will continue, indicating that the class of the flow cannot be determined at this time. The comparison of prob can be achieved by range match rules.

In an embodiment, the above range match rules can be installed in the match-action table of a programmable switch. Subsequently, the packet header field of the data is specified by the program, and the parser of the switch will parse the required data features from the data input to the switch according to the program instructions. Then, according to the range match rules stored in the match-action table, data matching is performed and corresponding actions are executed to achieve data classification. By storing different range match rules in the match-action table, line-speed data packet processing can be achieved.

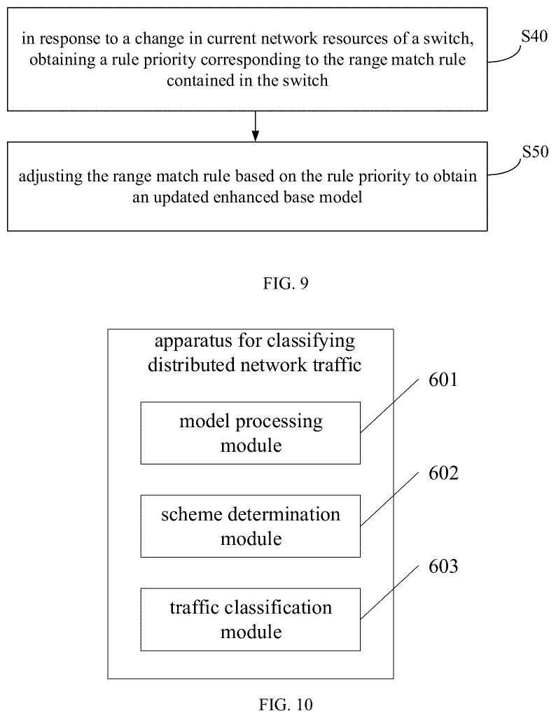

Based on the above embodiments, in this embodiment, as shown in FIG. 9, in order to improve the efficiency and flexibility of model updating, the method for distributively classifying network traffic may further include:

Step S40: in response to a change in current network resources of a switch, obtaining rule priorities corresponding to the range match rules contained.

Step S50: adjusting the range match rule based on the rule priority to obtain an updated enhanced base model.

It should be understood that in order to enhance the flexibility of model deployment, this embodiment introduces a lightweight model update mechanism. Each range match rule is obtained from the translation of the classification path, and the range match rule obtained after the translation of the classification path with a higher priority also has a higher priority. The range match rule with a higher priority will preferentially match the packet header vector. When available resources change, optimal model scaling can be achieved by adding (or deleting) range match rules with higher (or lower) priorities. In the online phase, it is critical to ensure that the model is updated in a timely manner to respond to dynamic traffic changes. For the enhanced base model on each switch, it can be updated with another model with the same number of range match rules. This update can be done by changing the range match rules alone, and there is no need to restart the switch.

This embodiment calculates the objective function of the plurality of enhanced base models in the offline phase based on topology awareness, and determines the allocation scheme of the offline phase based on the objective function and the Genetic Algorithm. The dynamic traffic transmission process of the plurality of enhanced base models in the online phase is modeled as a Markov decision process, the allocation scheme of the online phase is determined based on the deep enforcement learning method, and the Markov decision process is established to facilitate the deep reinforcement learning method. The enhanced base model allocation scheme is determined based on the allocation scheme of the offline phase and the allocation scheme of the online phase. Based on the enhanced base model allocation scheme, the classification paths in the plurality of enhanced base models are translated into range match rules. The range match rules are deployed to plurality of switches, and the network traffic is classified based on the range match rules through the plurality of switches to obtain classification results; when the current network resources of the switch change, the rule priority corresponding to the range match rules contained in the switch is obtained. The range match rules are adjusted based on the rule priority to obtain an updated enhanced base model. Compared with the conventional method for distributively classifying network traffic, the above method of this embodiment improves the classification accuracy by assigning a suitable enhanced base model to classify the corresponding network traffic; and adjusts the range match rule corresponding to the enhanced base model in the switch based on the rule priority, thereby improving the efficiency and flexibility of the model update.

In addition, an embodiment of the present application further provides a storage medium, on which a program for distributively classifying network traffic is stored. When the program for distributively classifying network traffic is executed by a processor, the steps of the method for distributively classifying network traffic described above are implemented.

As shown in FIG. 10, which is structural block diagram of an apparatus for distributively classifying network traffic according to an embodiment of the present application, the apparatus for distributively classifying network traffic provided in the embodiment of the present application includes: a model processing module 601, a scheme determination module 602, and a traffic classification module 603.

The model processing module 601 is configured to split an initial ensemble model into a plurality of classification paths, and reorganize and enhance the initial ensemble model based on the plurality of classification paths to obtain a plurality of enhanced base models. The initial ensemble model is configured to perform classification on the network traffic.

The scheme determination module 602 is configured to determine an enhanced base model allocation scheme through an allocation scheme in the offline phase and an allocation scheme in the online phase.

The traffic classification module 603 is configured to deploy the plurality of enhanced base models to a plurality of switches based on the enhanced base model allocation scheme, and classify the network traffic through the plurality of switches to obtain a classification result.

This embodiment splits the initial ensemble model into a plurality of classification paths, and reorganizes and enhances the initial ensemble model based on the plurality of classification paths to obtain the plurality of enhanced base models, the initial ensemble model is used to classify network traffic; determines the enhanced base model allocation scheme through the allocation scheme in the offline phase and the allocation scheme in the online phase; deploys the plurality of enhanced base models to plurality of switches based on the enhanced base model allocation scheme, and classifies the network traffic through the plurality of switches to obtain classification results. Compared with the conventional network traffic classification method, the above method of this embodiment is based on reorganizing and enhancing the models of the plurality of classification paths split from the initial ensemble model to obtain the enhanced base models, and deploys the enhanced base models to plurality of switches based on the enhanced base model allocation scheme, so that the network traffic is classified through the plurality of switches, thereby improving the classification accuracy of network traffic classification in scenarios with limited network resources.

Based on the above embodiment of the apparatus for distributively classifying network traffic of the present application, another embodiment of the apparatus for distributively classifying network traffic of the present application is provided.

In this embodiment, the model processing module 601 is further used to determine a flow set based on the flow sequence numbers of original data packets, and the flow sequence number of a data packet is obtained by performing a hash operation on preset features in the original data packet; extract crucial flow-level features from the original data packet, and construct a training set based on the crucial flow-level features; generate a tree-based ensemble model based on the flow set and the training set, and split the initial ensemble model into plurality of classification paths through the tree-based ensemble model.

In an embodiment, the model processing module 601 is further used to store the plurality of classification paths in a path pool, and reorganize the classification paths in the path pool to obtain plurality of base models; perform model filtering on the plurality of base models to obtain selected base models; and perform model enhancement on the selected models according to the selected base models and the priorities of the plurality of classification paths to obtain enhanced base models.

In an embodiment, the model processing module 601 is further used to obtain the traffic subsets, sample true classes and sample predicted classes corresponding to the plurality of classification paths respectively; and calculate the priorities of the plurality of classification paths based on the traffic subsets, the sample true classes and the sample predicted classes.

In an embodiment, the scheme determination module 602 is further used to calculate the objective function of the plurality of enhanced base models in offline phase based on topology awareness, and determine the allocation scheme of the offline phase based on the objective function and the Genetic Algorithm; model the dynamic traffic transmission process of the plurality of enhanced base models in the online phase as a Markov decision process, determine the allocation scheme of the online phase based on the deep reinforcement learning, and the Markov decision process is established to facilitate the deep reinforcement learning method; determine the enhanced base model allocation scheme based on the allocation scheme of the offline phase and the allocation scheme of the online phase.

In an embodiment, the traffic classification module 603 is further used to convert the classification paths in the plurality of enhanced base models into range match rules based on the enhanced base model allocation scheme; deploy the range match rules to plurality of switches, and classify the network traffic based on the range match rules through the plurality of switches to obtain classification results.

In an embodiment, the traffic classification module 603 is further used to obtain the rule priority corresponding to the range match rule contained in the switch when the current network resources of the switch change; adjust the range match rule based on the rule priority to obtain an updated enhanced base model.

Other embodiments or specific implementation methods of the apparatus for distributively classifying network traffic of the present application can refer to the above-mentioned method embodiments and will not be repeated here.

It should be noted that, in this article, the terms “include”, “comprises” or any other variations thereof are intended to cover non-exclusive inclusion, so that a process, method, article or system including a series of elements includes not only those elements, but also other elements not explicitly listed, or further includes elements inherent to such process, method, article or system. In the absence of further restrictions, an element defined by the sentence “comprises a . . . ” does not exclude the existence of other identical elements in the process, method, article or system including the element.

The above-mentioned embodiments of the present application are for description only and do not represent the advantages or disadvantages of the embodiments.

Through the description of the above implementation methods, those skilled in the art can clearly understand that the above-mentioned embodiment methods can be implemented by means of software plus a necessary general hardware platform, and of course by hardware, but in many cases the former is a better implementation method. Based on such an understanding, the technical solution of the present application is essentially or the part that contributes to the prior art can be embodied in the form of a software product, which is stored in a storage medium (such as ROM/RAM, magnetic disk, optical disk) as described above, and includes a number of instructions for a terminal device (which can be a mobile terminal, a computer, a server, or a network device, etc.) to execute the methods described in each embodiment of the present application.

The above are only some embodiments of the present application, and do not limit the scope of the present application thereto. Under the inventive concept of the present application, equivalent structural transformations made based on the description and drawings of the present application, or direct/indirect application in other related technical fields are included in the scope of the present application.

What is claimed is:

1. A method for distributively classifying network traffic, comprising:
splitting an initial ensemble model into a plurality of classification paths, and reorganizing and enhancing the initial ensemble model based on the plurality of classification paths to obtain a plurality of enhanced base models, wherein the initial ensemble model is configured to perform classification on the network traffic;
determining an enhanced base model allocation scheme through an allocation scheme in an offline phase and an allocation scheme in an online phase; and
deploying the plurality of enhanced base models to a plurality of switches based on the enhanced base model allocation scheme, and classifying the network traffic through the plurality of switches to obtain a classification result.

2. The method for distributively classifying network traffic according to claim 1, wherein the splitting the initial ensemble model into the plurality of classification paths comprises:
determining a flow set based on flow sequence numbers of original data packets, wherein the flow sequence number of a data packet is obtained by performing a hash operation on preset features in the original data packet;
extracting crucial flow-level features from the original data packet, and constructing a training set based on the crucial flow-level features; and
generating a tree-based ensemble model based on the flow set and the training set, and splitting the initial ensemble model into a plurality of classification paths through the tree-based ensemble model.

3. The method for distributively classifying network traffic according to claim 2, wherein the reorganizing and enhancing the initial ensemble model based on the plurality of classification paths to obtain the plurality of enhanced base models comprises:
storing the plurality of classification paths in a path pool, and reorganizing the classification paths in the path pool to obtain a plurality of base models;
performing model filtering on the plurality of base models to obtain selected base models; and
enhancing the selected base models according to the selected base models and priorities of the plurality of classification paths to obtain enhanced base models.

4. The method for distributively classifying network traffic according to claim 3, wherein after the performing model filtering on the plurality of base models to obtain the selected base models, the method further comprises:
obtaining traffic subsets, sample true classes, and sample predicted classes respectively corresponding to the plurality of classification paths; and
calculating priorities of the plurality of classification paths based on the traffic subsets, the sample true classes and the sample predicted classes.

5. The method for distributively classifying network traffic according to claim 1, wherein the determining the enhanced base model allocation scheme through the allocation scheme in the offline phase and the allocation scheme in the online phase comprises:
calculating an objective function of the plurality of enhanced base models in the offline phase based on topology awareness, and determining the allocation scheme for the offline phase based on the objective function and a Genetic Algorithm;
modeling a dynamic traffic transmission process of the plurality of enhanced base models in the online phase as a Markov decision process, and determining the allocation scheme in the online phase based on a deep reinforcement learning method, wherein the Markov decision process is established to facilitate the deep reinforcement learning method; and
determining an enhanced base model allocation scheme based on the allocation scheme in the offline phase and the allocation scheme in the online phase.

6. The method for distributively classifying network traffic according to claim 1, wherein the deploying the plurality of enhanced base models to the plurality of switches based on the enhanced base model allocation scheme, and classifying the network traffic through the plurality of switches to obtain the classification results comprises:
converting classification paths in the plurality of enhanced base models into range match rules based on the enhanced base model allocation scheme;
deploying the range match rules to the plurality of switches; and
classifying the network traffic based on the range match rules by the plurality of switches to obtain the classification result.

7. The method for distributively classifying network traffic according to claim 1, further comprising:
in response to a change in current network resources of a switch, obtaining a rule priority corresponding to the range match rule contained in the switch; and
adjusting the range match rule based on the rule priority to obtain an updated enhanced base model.

8. An apparatus for distributively classifying network traffic, comprising:
a model processing module configured to split an initial ensemble model into a plurality of classification paths, and reorganize and enhance the initial ensemble model based on the plurality of classification paths to obtain a plurality of enhanced base models, wherein the initial ensemble model is configured to perform classification on the network traffic;
a scheme determination module configured to determine an enhanced base model allocation scheme through an allocation scheme in an offline phase and an allocation scheme in an online phase; and
a traffic classification module configured to deploy the plurality of enhanced base models to a plurality of switches based on the enhanced base model allocation scheme, and classify the network traffic through the plurality of switches to obtain a classification result.

9. A device for distributively classifying network traffic, comprising:
a memory;
a processor; and
a program for distributively classifying network traffic stored in the memory and executable on the processor;
wherein the program for distributively classifying network traffic is configured to implement the method for distributively classifying network traffic according to claim 1.

10. A non-transitory computer-readable storage medium, wherein a program for distributively classifying network traffic is stored in the non-transitory computer-readable storage medium, and when executed by a processor, the method for distributively classifying network traffic according to claim 1 is implemented.
